(19) United States
(12) Patent Application Publication
(10) Pub. No.: US 2018/0304568 A1
(43) Pub. Date: Oct. 25, 2018

(54) Electronically Actuated Formed Bath Product Press

(71) Applicant: MUDDY SOAP CO., Cypress, TX (US)

(72) Inventor: Jerry Pyles, Cypress, TX (US)

(73) Assignee: MUDDY SOAP CO.,, Cypress, TX (US)

(21) Appl. No.: 15/957,634

(22) Filed: Apr. 19, 2018

Related U.S. Application Data
(60) Provisional application No. 62/488,547, filed on Apr. 21, 2017.

(51) Int. Cl. B30B 11/04; B30B 1/18; B30B 15/02; C11D 13/18

(52) U.S. Cl. CPC B30B 11/04; C11D 13/18; B30B 15/022; B30B 1/181

(57) ABSTRACT

The preferred embodiment of the invention comprises an electronically actuated press designed to compress materials in association with processes for manufacturing compressed soaps and bath products. An embodiment of the invention utilizes a DC electric linear actuator. The electronically actuated press produces less noise than pneumatic actuators and air compressors, require no operator adjustment to the pneumatic pressure settings and thereby provide an easier to use tool for the creation of “bath bomb” related products.

### CROSS-REFERENCE TO RELATED APPLICATIONS

This application claims the benefit of U.S. Provisional Application 62/488,547, filed on Apr. 21, 2017, which is incorporated herein in its entirety by reference.

### FIELD OF THE INVENTION

The present invention relates to devices for press apparatuses for manufacturing, more specifically for manufacturing bath-related and soap-related products, including especially “bath bombs” as that term is known to those skilled in the art.

### BACKGROUND OF THE INVENTION

The present inventor has recognized the problem of pressing formed bath products mechanically without the noise created by other solutions, or impracticality associated with the transport of such solutions due in part to excessive weight. Other solutions for the problem of pressing formed bath products mechanically exist in the prior art, though these present additional disadvantages.

Previous solutions for manufacturing pressed formed bath products require the utilization of pneumatic actuators and air compressors. In such prior art solutions, a press is driven by utilizing an external air compressor to drive a pneumatic ram. Such solutions, however, pose difficulties for many operators. Such difficulties include operator intervention to adjust the pneumatic pressure settings. Moreover, air compressors generate a high level of noise, making them impractical in many environments including home use environments. Further, such solutions remain dependent on the use of a compressed air source to operate, which often may be difficult to locate or utilize.

### BRIEF DESCRIPTION OF FIGURES

FIG. 1 depicts an oblique frontal view of the preferred embodiment of the invention.

FIG. 2 depicts a lateral view of the preferred embodiment of the invention.

FIG. 3 depicts the Frame Structure in the preferred embodiment of the invention.

FIG. 4 depicts an oblique view of the preferred embodiment of the invention.

FIG. 5 depicts the lowermost portion of the Frame Structure and associated components, including an embodiment of the Guide Plate, in the preferred embodiment of the invention.

FIG. 6 depicts an embodiment of the Guide Plate.

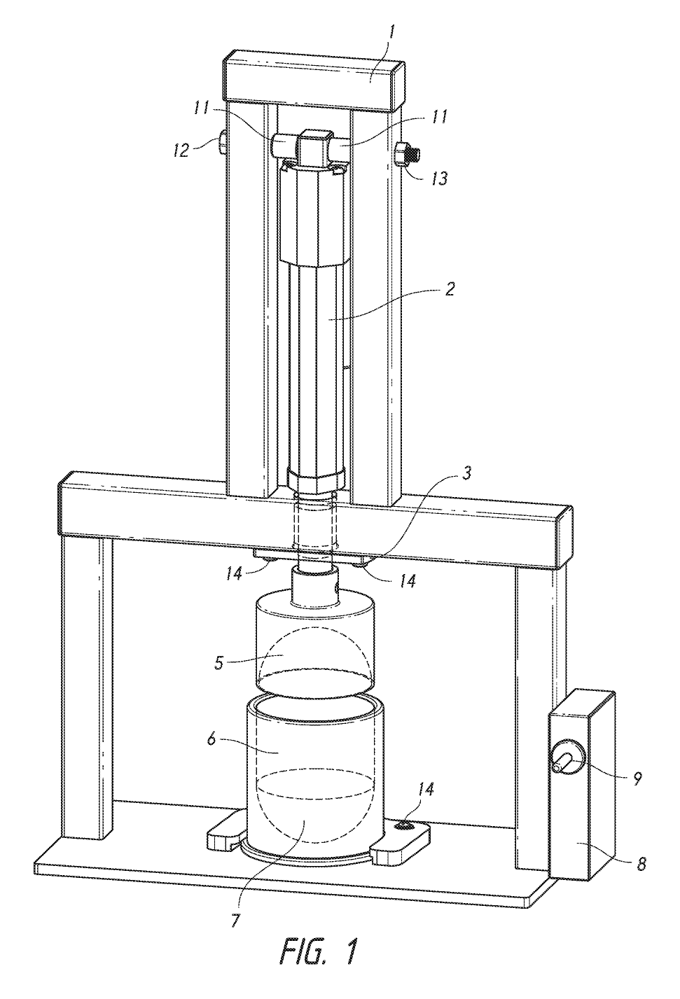

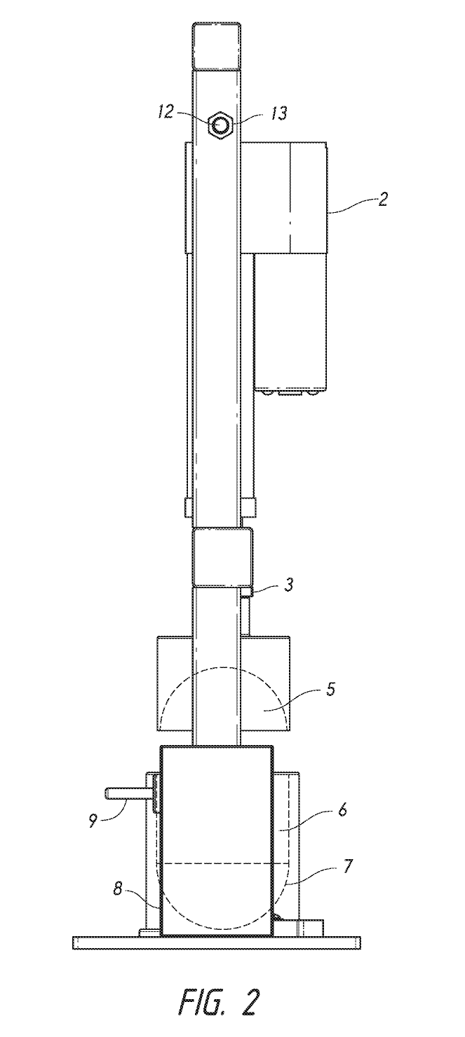

### BRIEF DESCRIPTION OF NUMERICAL REFERENCES IN FIGS.

1. Frame Structure in an embodiment of the invention.

2. Linear Actuator in an embodiment of the invention.

3. Alignment Bushing in an embodiment of the invention.

4. Guide Plate in an embodiment of the invention.

5. Mold Top in an embodiment of the invention.

6. Mold Shell in an embodiment of the invention.

7. Mold Bottom in an embodiment of the invention.

8. Switch Box in an embodiment of the invention.

9. Toggle Switch in an embodiment of the invention.

10. Power Converter in an embodiment of the invention.

### Legend Of Features

1. Frame Structure

2. Linear Actuator

3. Alignment Bushing

4. Guide Plate

5. Mold Top

6. Mold Shell

7. Mold Bottom

8. Switch Box

9. Toggle Switch

10. Power Converter

11. Spacer

12. Bolt

13. Nut

14. Screw

### DESCRIPTION OF THE INVENTION

The preferred embodiment of the present invention is described as a Electronically Actuated Formed Bath Product Press. Generally, the inventor intends for the Electronically Actuated Formed Bath Product Press to function as an electronically-actuated formed bath product press. The present inventor has recognized that embodiments of the invention are useful in association with the process of manufacturing compressed bath products, including soap-related products, such as bath bombs.

In varying embodiments, the invention may comprise any subset of, or all of, the following components: (1.) frame structure, (2.) linear actuator, (3.) alignment bushing, (4.) guide plate, (5.) mold top, (6.) mold shell, (7.) mold bottom, (8.) switch box, (9.) toggle switch, (10.) power converter, (11.) spacer, (12.) bolt, (13.) nut, (14.) screw.

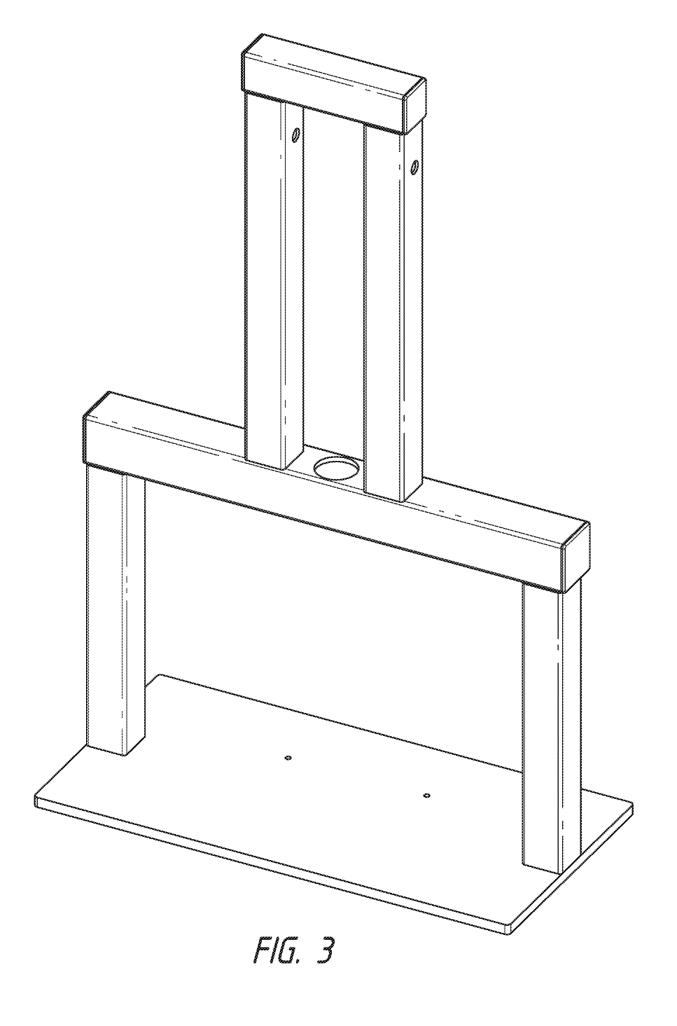

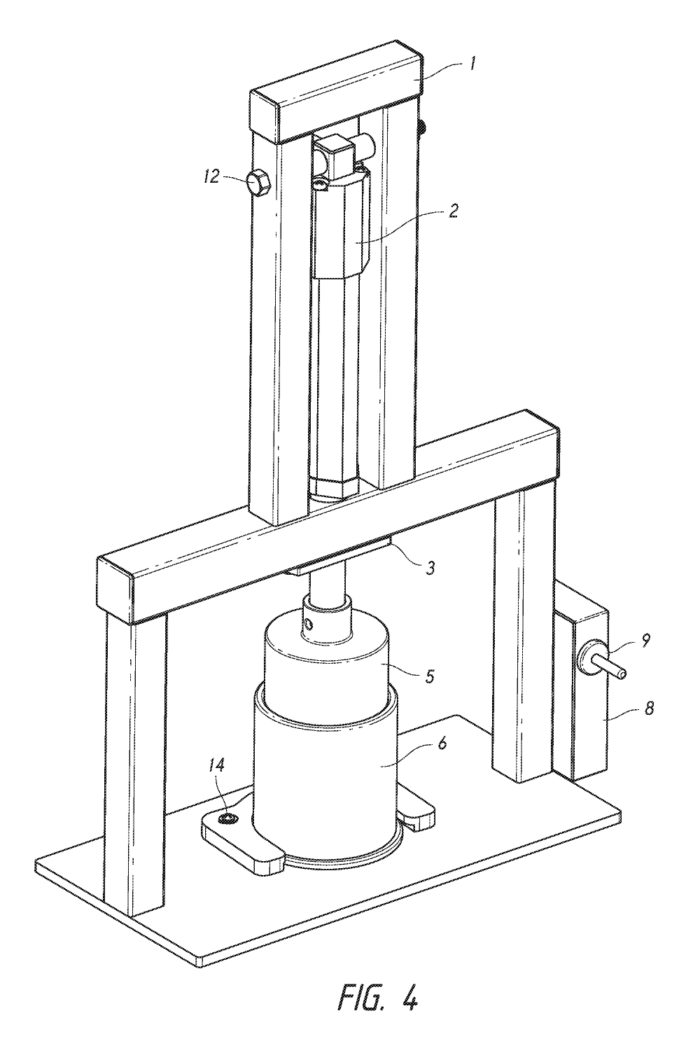

An embodiment of the invention incorporates a Frame Structure 1. The Frame Structure 1 in an embodiment of the invention is described as an apparatus comprising a lower portion, such as a base plate; support appendages, such as tubes; and an upper portion, such as a crossbar; welded together to provide the primary support structure of the preferred embodiment of the invention. In an embodiment, the Frame Structure 1 is comprised primarily of aluminum. In the preferred embodiment, the Frame Structure 1 is a powder-coated, aluminum welded square tubing and plate. In varying embodiments, a variety of plastic or metal tubing or solid structures could comprise the Frame Structure 1. In varying embodiments, the configuration may vary to accommodate a variety of sizes of molds. In the preferred embodiment of the invention, the Frame Structure 1 is configured to the following dimensions: the lowermost portion comprising a base plate twelve inches long by six inches wide, with attachment points for a Guide Plate 4 four and one quarter inches from either side laterally; a center beam twelve inches long, comprising aluminum square tubing one and one quarter inches across; two top supports linking the center beam to the top beam, comprising aluminum square tubing one inch across, each approximately eight and one half inches high; and two bottom supports linking the center beam to the base plate, comprising aluminum square tubing one inch across, just over seven inches high. In the preferred embodiment, the portions described in the preceding sentence are welded together in such configuration to form the structure depicted in FIG. 3. In varying embodiments of the invention, the Frame Structure 1 may be enclosed by external cladding or remain open such that its components remain in full view of the user. In an embodiment of the invention, the upper portion Frame Structure 1 incorporates attachment mechanisms, such as holes for passage of a bolt tightened with a nut and optionally incorporating a spacer, to retain the Linear Actuator 2.

An embodiment of the invention incorporates a Linear Actuator 2. A Linear Actuator 2 in an embodiment of the invention is described as comprising an actuating rod and a piston. In an embodiment, the Linear Actuator 2 functions by converting DC power into linear force by mechanisms known by those skilled in the art. The present inventor has recognized several advantages associated with the utilization of a Linear Actuator 2, especially in comparison to pneumatic actuators, including that DC-powered Linear Actuator 2 as that intended to be utilized in association with embodiments of the invention require less noise, no adjustment to the pneumatic pressure settings and are thereby easier for many operators to use.

In an embodiment of the invention, a Linear Actuator 2 and a Frame Structure 1 are related. The Linear Actuator 2 and Frame Structure 1 relate to one another in such embodiment as the Linear Actuator 2 suspends within the upper section of the Frame Structure 1. Optionally, the suspension of the Linear Actuator 2 within the Frame Structure 1 is facilitated with one or more bolts, spacers and nuts configured to traverse through aligned apertures contain within the bodies of both the Frame Structure 1 and the Linear Actuator 2 to facilitate attachment.

An embodiment of the invention incorporates an Alignment Bushing 3. An Alignment Bushing 3 in an embodiment of the invention is described as configured to be insertable into an aperture located within the bottom portion of the Frame Structure 1 to provide inferior alignment for the Linear Actuator 2, which is attached to the Frame Structure 1 superiorly. In the preferred embodiment, the Alignment Bushing 3 is comprised of ABS machined and/or thermal-formed plastic.

In an embodiment of the invention, an Alignment Bushing 3 and a Frame Structure 1 are related. Alignment Bushing 3 and Frame Structure 1 relate to one another in such embodiment as the Alignment Bushing 3 attaches to the lower portion of the Frame Structure 1. In an embodiment, such attachment takes place via two screws configured to traverse through two apertures in both the Alignment Bushing 3 and the underside of the Frame Structure 1, and optionally affix via a nut or similar mechanism.

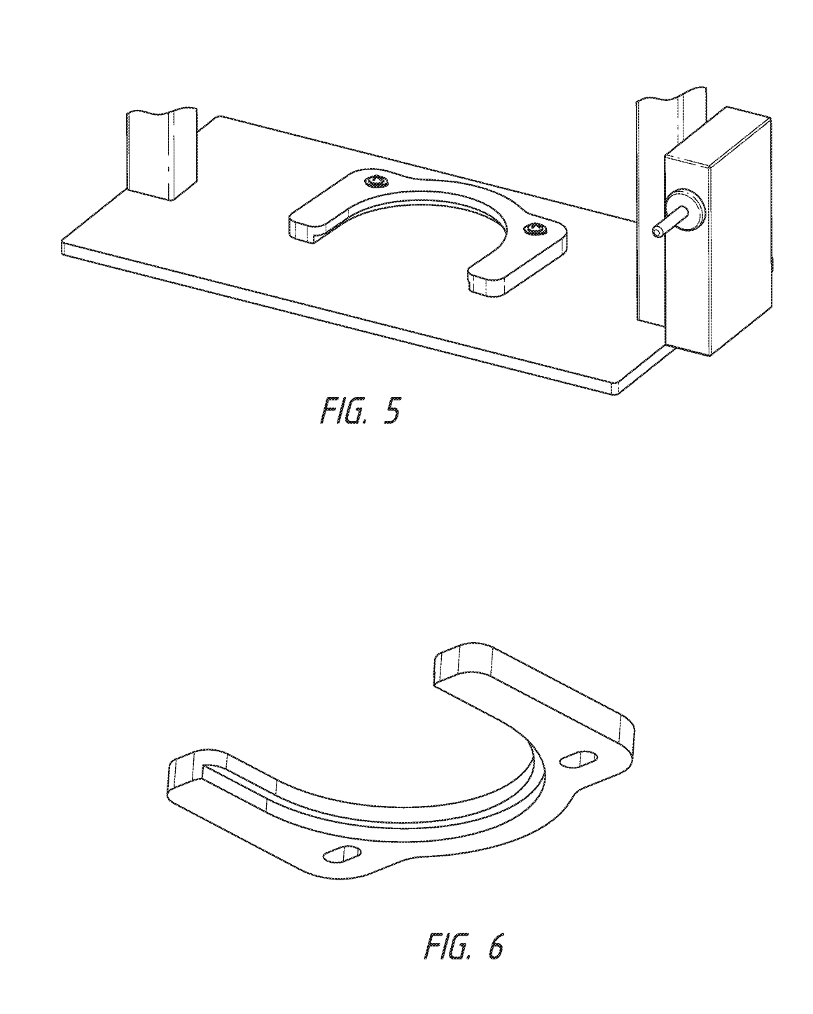

An embodiment of the invention incorporates a Guide Plate 4. A Guide Plate 4 in an embodiment of the invention is described as an alignment mechanism to ensure the controlled alignment of the Mold. The present inventor has recognized that proper alignment of the Mold is desirable associated with effective compression in association with actuation of the linear actuator. Guide Plate 4 in an embodiment of the invention is also described as a shaped mass affixed to the superior aspect of the lowermost portion of the Frame Structure 1. In the preferred embodiment, the Guide Plate 4 is comprised of Acroylonitrile Butadiene Styrene (ABS) or High Density Polyethelyne (HDPE) machined plastic. In varying embodiments, the Guide Plate 4 may be attached to the base plate of the Frame Structure 1, as depicted in FIG. 5. In varying embodiments, the Guide Plate 4 is custom formed to the external dimensions of the Mold. In alternative embodiments, the Guide Plate 4 comprises two or more linear masses. In an embodiment, the two or more linear masses comprising the Guide Plate 4 are angled such that objects interacting with the Guide Plate 4 are placed in a position substantially centered below the Linear Actuator 2.

In an embodiment of the invention, Guide Plate 4 and Frame Structure 1 are related. Guide Plate 4 and Frame Structure 1 are related to one another in such embodiment as Guide Plate 4 affixes to the superior aspect of the lowermost portion of the Frame Structure 1. In varying embodiments, such affixation is accomplished in any variety of linear or curved shapes and configurations.

An embodiment of the invention incorporates a mold. In an embodiment of the invention, the mold comprises any or all of a Mold Top 5, a Mold Shell 6, and a Mold Bottom 7. In the preferred embodiment of the invention, the mold and its subcomponents are comprised of Acroylonitrile Butadiene Styrene (ABS) or High Density Polyethelyne (HDPE) machined plastic. The preferred embodiment of the invention incorporates a Mold Top 5. A Mold Top 5 in an embodiment of the invention is described as a shaped containment mechanism configured to attach to the inferior end of the Linear Actuator 2. The Mold Top 5 in an embodiment of the invention is also described as configured to be attached to the inferior end of the Actuator Rod. Such attachment may optionally take place by pressure fit and/or by use of a retaining pin.

In an embodiment of the invention, a Mold Top 5 and a Linear Actuator 2 are related. The Mold Top 5 and Linear Actuator 2 are related to one another in such embodiment as the Mold Top 5 affixes to the inferior end of the Linear Actuator 2 by a variety of attachment mechanisms as known by those skilled in the art. The present inventor has recognized an object of such attachment, namely to transfer compressive force delivered via the Linear Actuator 2 to the contents contained below the Mold Top 5.

A Mold Shell 6 in an embodiment of the invention is described as a containment mechanism allowing the contents placed within to receive the compressive forces between the Mold Top 5 and Mold Bottom 7 during actuation.

In an embodiment of the invention, Mold Shell 6 and Guide Plate 4 are related. Mold Shell 6 and Guide Plate 4 relate to one another in such embodiment as the Guide Plate 4 assumes a cross-sectional shape that accommodates and retains the Mold Shell 6 in an optimal position for actuation. In an embodiment, the Guide Plate 4 corresponds to the dimensions of the Mold Shell 6.

In an embodiment of the invention, Mold Shell 6 and Mold Top 5 are related. In such embodiment, Mold Top 5 relates to the Mold Shell 6 by facilitating slidable interacting with the Mold Shell 6 to enable compressive force to be applied to the contents within.

An embodiment of the invention incorporates a Mold Bottom 7. Mold Bottom 7 in an embodiment of the invention is described as the removable inferior aspect of the containment mechanism for the materials subject to compression via actuation.

In an embodiment of the invention, Mold Bottom 7 and Guide Plate 4 are related. Mold Bottom 7 and Guide Plate 4 relate in such embodiment as Guide Plate 4 assumes a shape exactly or approximately corresponding to the exterior aspect of the Mold Bottom 7. In such embodiment, Guide Plate 4 is thereby able to retain the Mold Bottom 7 in an optimal position for actuation.

In an embodiment of the invention, Mold Bottom 7 and Mold Top 5 are related. Mold Bottom 7 and Mold Top 5 relate to one another in such embodiment as the Mold Bottom 7 provides the bottom containment for the contents compressed by the Mold Top 5 as the Linear Actuator 2 transfers downward force through the Mold Top 5.

In an embodiment of the invention, Mold Bottom 7 and Mold Shell 6 are related. Mold Bottom 7 and Mold Shell 6 relate to one another in such embodiment as the mold shell 6 slidably encompasses or alternatively slidably fits within the wall of Mold Bottom 7.

An embodiment of the invention incorporates a Switch Box 8. Switch Box 8 in an embodiment of the invention is described as an enclosure for the toggle switch and associated electronics.

In an embodiment of the invention, Switch Box 8 and Frame Structure 1 are related. Switch Box 8 and Frame Structure 1 relate to one another in such embodiment as the Switch Box 8 is affixed to the side of the Frame Structure 1 or its associated components in a variety of configurations.

In an embodiment of the invention, Switch Box 8 and Linear Actuator 2 are related. Switch Box 8 and Linear Actuator 2 relate to one another in such embodiment as the Switch Box 8 facilitates delivery of DC power in varying polarities through to the Linear Actuator 2.

An embodiment of the invention incorporates a Toggle Switch 9. A Toggle Switch 9 in an embodiment of the invention is described as the mechanism the user can control delivery of externally provided DC power to the Linear Actuator 2.

In an embodiment of the invention, Toggle Switch 9 and Switch Box 8 are related. Toggle Switch 9 and Switch Box 8 relate to one another in such embodiment as Switch Box 8 encompasses the wiring necessary for Toggle Switch 9 to function to receive DC power from the power converter and controllably deliver DC power to the Linear Actuator 2.

In an embodiment of the invention, Toggle Switch 9 and Linear Actuator 2 are related. Toggle Switch 9 and Linear Actuator 2 relate to one another in such embodiment as Toggle Switch 9 controls the flow of DC power to the Linear Actuator 2, such that when Toggle Switch 9 can optionally control the flow of DC power in a desired polarity to the Linear Actuator 2 such that Linear Actuator 2 extends its piston in a downward trajectory, or can otherwise optionally control the flow of DC power in a desired polarity to the Linear Actuator 2 such that Linear Actuator 2 extends its piston in a upward trajectory, or when the Toggle Switch 9 is in the “off” position, the flow of DC power to the Linear Actuator 2 is terminated.

An embodiment of the invention incorporates a Power Converter 10. A Power Converter 10 in an embodiment of the invention is described as a tool to convert supplied AC power to DC power for use by the Linear Actuator 2, as known by those skilled in the art. The present inventor has recognized that AC power remains readily available, and with the use of a Power Converter 10 as known in the art is a preferable alternative to the power supplied by an air compressor which is not readily available, noisy and more difficult for an end user to utilize.

In an embodiment of the invention, Power Converter 10 and Switch Box 8 are related. Power Converter 10 and Switch Box 8 are related to one another in such embodiment as Power Converter 10 is connected to Switch Box 8 via a power delivery wire as known by those skilled in the art.

In an embodiment of the invention, Power Converter 10 and Toggle Switch 9 are related. Power Converter 10 and Toggle Switch 9 are related to one another in such embodiment as the Toggle Switch 9 controls the flow of DC power from the Power Converter 10 to the Linear Actuator 2.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

I claim:

1. An electric press for creating bath products, comprising:
a frame structure,
a linear actuator,
a guide plate, and
a mold.

2. The electric press of claim 1, said mold comprising a mold top, a mold bottom, and a mold shell.

3. The electric press of claim 1, further comprising an alignment bushing.

4. The electric press of claim 1, further comprising a switch box.

5. The electric press of claim 1, said guide plate comprising two linear masses.
